(19) United States
(12) Patent Application Publication
(10) Pub. No.: US 2017/0193172 A1
(43) Pub. Date: Jul. 6, 2017

(54) CLOUD-BASED OPERATION ADMINISTRATION PLATFORM

(71) Applicant: Accenture Global Solutions Limited, Dublin (IE)

(72) Inventors: Katherine MELLE, Boston, MA (US); John R. SHERMAN, Hoboken, NJ (US); Nicolae E. CECAN, Princeton, NJ (US)

(21) Appl. No.: 15/271,580

(22) Filed: Sep. 21, 2016

Related U.S. Application Data
(60) Provisional application No. 62/273,070, filed on Dec. 30, 2015.
(60) Provisional application No. 62/273,060, filed on Dec. 30, 2015.

(51) Int. Cl. G06F 19/00; G06F 3/0482

(52) U.S. Cl. CPC G06F 19/327; G06F 3/0482

(57) ABSTRACT

A device may receive operation information that identifies a set of operations to be performed with regard to a client by a set of workers. The device may generate, based on the operation information, a program that identifies the set of operations and an order in which the set of operations are to be performed. The device may provide, to one or more user devices associated with the one or more workers, respective portions of the program associated with the respective operations that are assigned to the one or more workers. The device may receive, from the one or more user devices, performance information that identifies completion states of the respective operations. The device may automatically generate an updated program based on the performance information. The device may store and/or provide the updated program.

### RELATED APPLICATION

This application claims priority under 35 U.S.C. §119 to U.S. Provisional Patent Application No. 62/273,060, filed on Dec. 30, 2015, and to U.S. Provisional Patent Application No. 62/273,070, filed on Dec. 30, 2015, the content of which is incorporated by reference herein in its entirety.

### BACKGROUND

Health related services may be provided by multiple different entities that perform different tasks with respect to a client. For example, different healthcare providers may perform different tasks with regard to a patient. The different entities may be associated with different companies, different functions, different locations, or the like.

### SUMMARY

According to some possible implementations, a device may include one or more processors. The one or more processors may receive operation information that identifies a set of operations to be performed with regard to a client by a set of workers. The one or more processors may generate, based on the operation information, a program that identifies the set of operations and an order in which the set of operations are to be performed. The program may include assignment information that identifies one or more workers, of the set of workers, that have been assigned to perform respective operations of the set of operations. The one or more processors may provide, to one or more user devices associated with the one or more workers, respective portions of the program associated with the respective operations that are assigned to the one or more workers. The one or more processors may receive, from the one or more user devices, performance information that identifies completion states of the respective operations. The one or more processors may automatically generate an updated program based on the performance information. The updated program may include one or more modified operations that are determined based on one or more of the set of operations and the performance information. The one or more processors may store and/or provide the updated program.

According to some possible implementations, a method may include receiving, by a device, operation information that identifies a set of operations to be performed with regard to a client by one or more workers. The method may include generating, by the device and based on the operation information, a program that identifies the set of operations and an order in which the set of operations are to be performed. The program may include assignment information that identifies particular operations, of the set of operations, that have been assigned to be performed by the one or more workers. The order may be based on logical relationships between the set of operations. The method may include providing, by the device and to one or more user devices associated with the one or more workers, a graphical user interface. The graphical user interface may be generated based on the program. The graphical user interface may provide information relevant to performing the operations that have been assigned to the one or more workers. The method may include receiving, by the device, performance information that identifies a completion state of the set of operations. The method may include generating, by the device, an updated program based on the performance information. The updated program may identify one or more incomplete operations of the set of operations and one or more completed operations of the set of operations. The method may include storing and/or providing, by the device, the updated program.

According to some possible implementations, a non-transitory computer-readable medium may store one or more instructions that, when executed by one or more processors, may cause the one or more processors to receive operation information that identifies a set of operations to be performed with regard to a client by a set of workers. The one or more instructions, when executed by one or more processors, may cause the one or more processors to generate, based on the operation information, a program that identifies the set of operations and an order in which the set of operations are to be performed. The program may include assignment information that identifies one or more workers, of the set of workers, that have been assigned to perform respective operations of the set of operations. The one or more instructions, when executed by one or more processors, may cause the one or more processors to provide, to one or more user devices associated with the one or more workers, respective portions of the program associated with the respective operations that are assigned to the one or more workers. The one or more instructions, when executed by one or more processors, may cause the one or more processors to receive, from the one or more user devices, performance information that identifies completion states of the respective operations. The one or more instructions, when executed by one or more processors, may cause the one or more processors to automatically generate an updated program based on the performance information. The updated program may identify one or more incomplete operations, of the set of operations, and one or more completed operations of the set of operations. The one or more instructions, when executed by one or more processors, may cause the one or more processors to store and/or provide the updated program.

### BRIEF DESCRIPTION OF THE DRAWINGS

FIGS. 1A and 1B are diagrams of overviews of an example implementation described herein;

FIG. 2 is a diagram of an example environment in which systems and/or methods, described herein, may be implemented;

FIG. 3 is a diagram of example components of one or more devices of FIG. 2;

FIG. 4 is a flow chart of an example process for generating a program based on operations to be performed with regard to a client;

FIG. 5 is a flow chart of an example process for providing an updated program based on completion of operations to be performed with regard to a client; and

FIGS. 6A and 6B are diagrams of example graphical user interfaces that may be generated based on the examples shown in FIGS. 4 and 5.

### DETAILED DESCRIPTION

The following detailed description of example implementations refers to the accompanying drawings. The same reference numbers in different drawings may identify the same or similar elements.

An entity, such as a life sciences entity, a health care entity, a pharmaceutical company, an insurance company, a hospital, a rehabilitation facility, or the like, may offer one or more services to a client (e.g., a patient, a person associated with a patient, etc.), aimed at enhancing a client experience. For example, the entity may offer services associated with providing support throughout a treatment, such as a service associated with enrolling the client for the treatment, a service associated with ensuring that the client adheres to the treatment, a service associated with supporting the client throughout the treatment, or the like.

However, provisioning of such client services may be disjointed and/or separate (e.g., between various teams associated with providing each service), which may negatively impact the client experience. This may be problematic when a workflow of client services is complex and includes parallel operations, dependencies, conditional relationships, or the like. Moreover, the disjointed and/or separate provisioning of the client services may prevent the entity from gathering information, associated with the treatment (e.g., client data, treatment data, data associated with the services, etc.), that, if analyzed, may provide insight into improvement of the patient services.

Implementations described herein may provide a workflow orchestration component (herein referred to as an operations platform) to support one or more computer-implemented client services related to a set of operations (e.g., a workflow). The set of operations may include conditional relationships, operations to be performed in parallel, particular information to be gathered, a particular order of operations to be performed, or the like.

In some implementations, the operations platform may generate a program (e.g., a sequence of activities, tasks, events, etc.) associated with the set of operations. Further, the operations platform may automatically determine an order of the set of operations based on information associated with the set of operations and/or the operation information. Based on the program, the operations platform may cause the set of operations to be performed, and may monitor performance of the set of operations. For example, the operations platform may automatically assign operations to be performed, may automatically determine that the operations have been performed, and may update the program to automatically cause remaining operations of the program to be performed. In some implementations, the operations platform may be associated with security measures that improve security of the program and/or client information associated with the program. The operations platform may further provide users (e.g., nurses, physicians, patients, etc.) with a visualization of the set of operations as related to the one or more client services.

In this way, the operations platform facilitates generation, performance, and administration of complex workflows that include parallel, hierarchical, and/or conditional operations. By automatically assigning operations to be performed and providing information relevant to performance of the assigned operations, the operations platform conserves computational resources that would otherwise be used to manually identify operations to be performed and to obtain information relevant to performing the operations. Further, the operations platform may reconfigure operations based on previously performed operations (e.g., based on results of the previously performed operations and/or information gathered based on the previously performed operations) which improves provision of health related services.

Furthermore, by automatically assigning particular tasks to be performed by particular workers, and by controlling the manner in which information is provided to and obtained from the particular workers, the operations platform improves security of the information (e.g., based on providing and obtaining the information via a secure connection, based on providing and obtaining the information when the worker is located in a particular location, etc.).

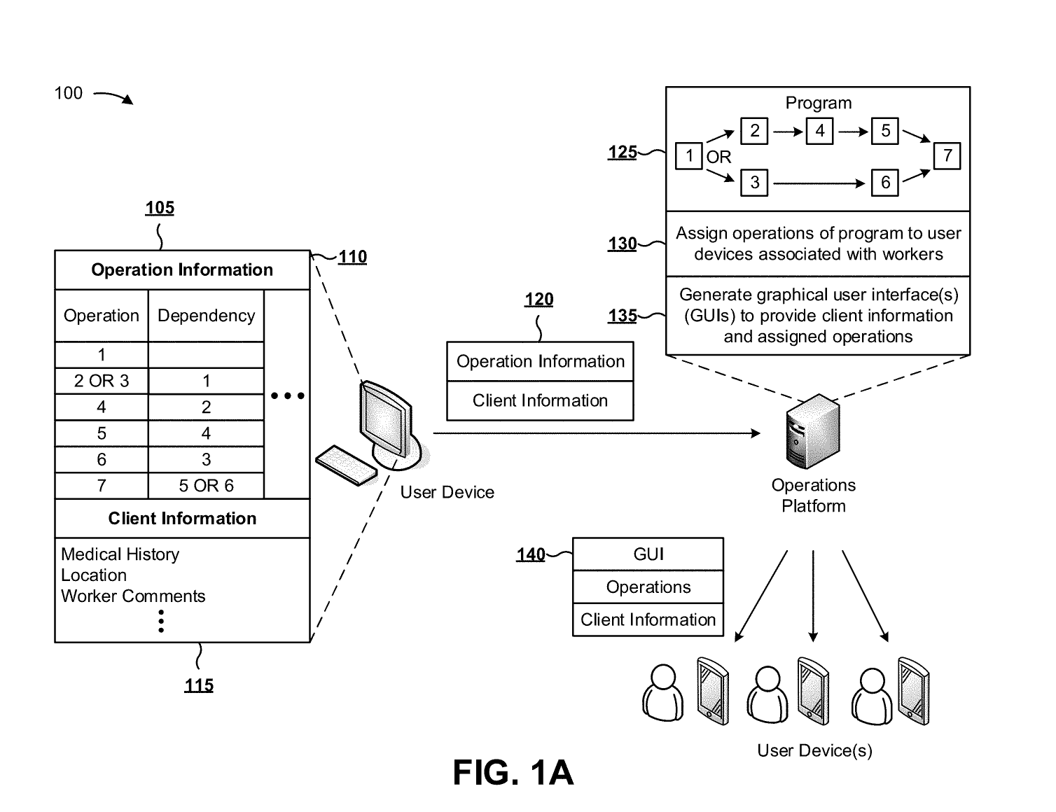

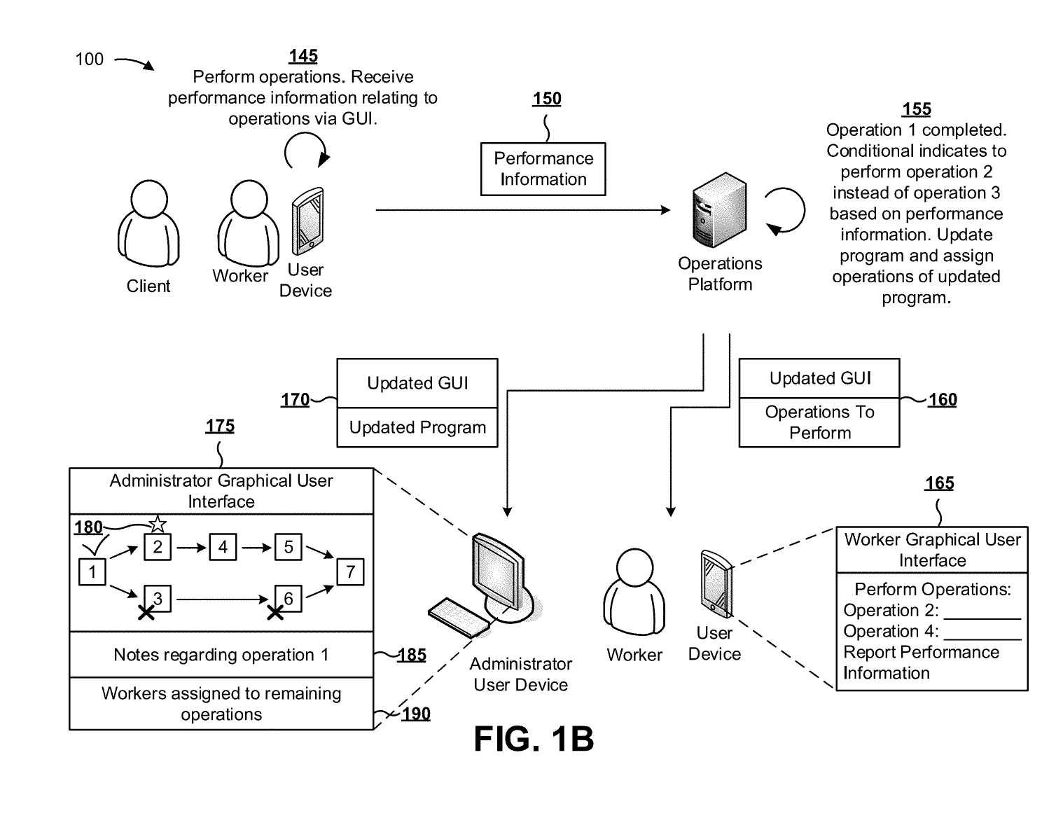

FIGS. 1A and 1B are diagrams of overviews of an example implementation 100 described herein. As shown in FIG. 1A, example implementation 100 may include a user device which may store operation information related to operations to be performed with regard to a client. Example implementation 100 may further include an operations platform which may generate a program (e.g., a sequence of activities, tasks, events, or the like) based on the operation information, and one or more user devices, each which may be used by a worker to perform operations identified by the program.

As shown by reference number 105, the user device may receive or store operation information and/or client information relating to the client. As shown by reference number 110, the operation information may identify a set of operations (e.g., operations 1-7, as shown). An operation may include, for example, training a client, mailing a letter, performing a medical procedure, inputting information, automatically obtaining a sensor measurement, or the like. As further shown, the operation information may identify dependencies of the operations (e.g., prerequisites, inputs for particular operations that are outputs of other operations, etc.).

In some implementations, the operation information may further identify requirements associated with the operations (e.g., indicated here by ellipses). For example, for a particular operation, a requirement may identify particular information that is required to perform the particular operation, a particular tool or component that is required to perform the particular operation, a quantity of workers required to perform the operation, or the like. Additionally, or alternatively, the operation information may identify a hierarchy of the operations, an order in which the operations are to be performed, types associated with the operations, or the like.

As shown by reference number 115, the user device may also store or have access to client information (e.g., medical information, location information, worker comments regarding the client, or the like). As shown by reference number 120, the user device may provide the operation information and/or the client information to the operations platform.

As shown by reference number 125, the operations platform may generate, based on the operation information, a program that identifies the operations to be performed. The program may also identify an order in which to perform the operations, logical relationships between the operations, workers to perform the operations, criteria based on which workers are to be selected, client information associated with the operations, geographical location of the operations, information to be gathered during performance of the operations, or the like. For example, here, the program identifies the logical relationship between operations 2 and 3 (i.e., perform one of operation 2 or operation 3 based on a result of performing operation 1) and the hierarchical relationship between each of the operations. In some cases, the operations platform may determine client information that relates to particular operations, and may generate the program based on the client information. For example, the program may identify client information that is relevant and/or useful for a worker that is to perform each operation (e.g., based on an operation type, etc.).

As shown by reference number 130, the operations platform may assign operations of the program to user devices associated with workers who are to perform the operations. As shown by reference number 135, the operations platform may generate a graphical user interface to provide information regarding the program and/or the operations to be performed. Additionally, or alternatively, the operations platform may generate a template for a graphical user interface, and a user device may generate the graphical user interface based on the template. Additionally, or alternatively, the operations platform may provide user devices with access to the graphical user interface (e.g., based on a credential, based on locations of the user devices, etc.). For example, the graphical user interface may provide information relating to client information and operations to be performed by a worker with regard to the client.

As shown by reference number 140, the operations platform may provide the program and/or the graphical user interface to user devices associated with workers who are to perform the operations (e.g., field nurses, traveling medical professionals, technicians, etc.), and/or to user devices associated with entities who may utilize the client information (e.g., administrative workers, insurance representatives, medical professionals, etc.). For example, the operations platform may assign one or more operations of the program to be performed by a particular worker that is associated with a particular user device. The operations platform may provide, to the particular worker, a graphical user interface that identifies the one or more operations, and that provides client information regarding a client for which the one or more operations are to be performed. In some cases, the operations platform may provide the graphical user interface via a secure connection. Additionally, or alternatively, the operations platform may provide the graphical user interface based on the user device being located at a particular location (e.g., a secure location).

As shown in FIG. 1B, and as shown by reference number 145, a worker may perform assigned operations, and may provide performance information to the user device. The performance information may identify a completion state of each operation assigned to the worker. For example, the performance information may indicate whether an operation is complete, incomplete, impossible to complete (e.g., based on a changed circumstance or a lack of required information or tools), or the like. As another example, the performance information may include information or data relating to performing the one or more operations. For example, when a worker is to gather particular information based on performing the action, the performance information may include the particular information.

As shown by reference number 150, the operations platform may receive the performance information from the user device. For example, the performance information may indicate that operation 1 has been completed, and may further include condition information indicating that operation 2 should be performed instead of operation 3 (e.g., based on the logical relationship identified by the program, and based on a result of performing operation 1).

As shown by reference number 155, the operations platform may generate and provide an updated program based on the performance information. The updated program may identify operations of the original program that have been performed, operations that are no longer to be performed (e.g., based on condition information), operations that have yet to be performed, operations that are to be newly performed (e.g., operations that are not included in the original program and are included in the updated program), updated client information associated with the set of operations, or the like. Here, the operations platform determines that operation 1 has been performed, and determines that a conditional or logical relationship of the program indicates to perform operation 2 instead of operation 3. As an example, operation 1 may include determining a measurement, and the program may indicate to selectively perform operation 2 or operation 3 based on whether the measurement satisfies a threshold. In some implementations, the operations platform may modify operations to be performed in association with the updated program (e.g., based on performance information associated with one or more operations).

As further shown, the operations platform may assign operations of the updated program to be performed by one or more workers (e.g., the same workers that performed the operations of the original program, or different workers than those that performed the operations of the original program). In some implementations, the operations platform may update a graphical user interface based on the updated program.

As shown by reference number 160, the operations platform may provide the updated program (e.g., part of or all of the updated program) to a user device associated with a worker that is assigned to perform at least a portion of remaining operations of the updated program. As further shown, the operations platform may provide information that identifies the operations assigned to the worker. As shown by reference number 165, the operations platform may provide an updated graphical user interface to the user device.

As further shown, the updated graphical user interface for the worker may identify remaining assigned operations for the worker to perform. For example, a particular worker may be available (e.g., qualified, suitable, located appropriately) to be assigned to perform operations 2, 3, and 4. In this case, as the performance information indicated that operation 2 and not operation 3 is to be performed, the graphical user interface may provide an indication to the particular worker that operations 2 and 4 are to be performed by the particular worker, as shown.

As shown by reference number 170, the operations platform may also provide part of or all of the updated program to a user device associated with an administrator (e.g., an administrator of the program, an insurance entity, a health care administrator, etc.). As shown by reference number 175, the operations platform may provide an updated graphical user interface to the user device associated with the administrator. As further shown, the updated graphical user interface provided to the administrator user device may be different than the updated graphical user interface provided to the user device associated with the worker. For example, the operations platform may determine that the administrator user device is associated with an administrator (e.g., based on a credential associated with the administrator user device, based on a device identifier associated with the administrator user device, etc.), and may generate and/or provide an updated graphical user interface that provides information relevant to or useful to the administrator. Thus, the operations platform conserves processor and/or other computer resources that would otherwise be used to obtain information regard the program via a graphical user interface that is not properly configured for the administrator.

As shown by reference number 180, the updated graphical user interface may provide information indicating operation 1 has been completed (e.g., based on a displayed check mark), that operation 2 has been selected over operation 3 (e.g., based on a displayed star), and that operations 3 and 6 are, therefore, not to be performed (e.g., based on x marks displayed in association with operations 3 and 6). As shown by reference number 185, the updated graphical user interface may also include notes regarding operation 1 (e.g., information gathered by the worker who performed operation 1). As shown by reference number 190, the updated graphical user interface may also include information identifying workers that are assigned to the remaining operations to be performed with regard to the client.

Thus, the updated graphical user interface associated with the administrator user device may provide information that is relevant to an administrator, whereas the updated graphical user interface associated with the worker may provide information that is relevant to a worker that is assigned to perform operations. In this way, performance of a set of operations that includes conditionals, dependencies, and/or a hierarchical order of tasks is improved. Furthermore, security of information associated with the set of operations is improved based on using the operations platform to manage the information associated with the set of operations. For example, the program may require that particular security protocols be followed, may use secure sessions to transfer information relating to the set of operations, or the like.

By automatically tracking and administering performance of operations, the operations platform improves efficiency of performance of the operations and enables reconfiguration of the operations in real-time or near real-time (e.g., real-time or substantially real-time) relative to when the operations are reconfigured manually. Furthermore, by providing information regarding an updated program to one or more user devices, the operations platform may synchronize the user devices of multiple workers, clients, and/or administrators with regard to the status of the operations. In this way, uniformity of performance of operations is improved. Further, the operations platform may enable analysis of performance information relating to performance of operations, which improves provision of health related services.

As indicated above, FIGS. 1A and 1B are provided merely as examples. Other examples are possible and may differ from what was described with regard to FIGS. 1A and 1B.

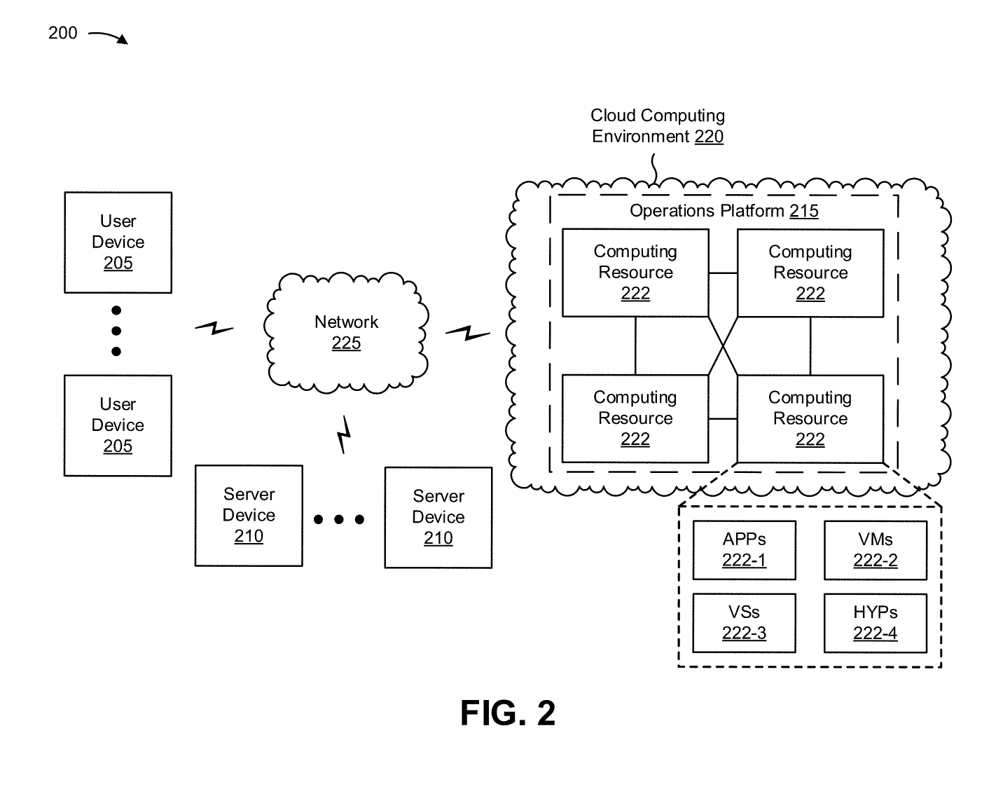

FIG. 2 is a diagram of an example environment 200 in which systems and/or methods described herein may be implemented. As shown in FIG. 2, environment 200 may include one or more user devices 205, one or more server devices 210, an operations platform 215 hosted within a cloud computing environment 220, and a network 225. Devices of environment 200 may interconnect via wired connections, wireless connections, or a combination of wired and wireless connections.

User device 205 includes one or more devices capable of receiving, generating, storing, processing, and/or providing information associated with operations platform 215, such as information associated with one or more applications of operations platform 215. For example, user device 205 may include a communication and computing device, such as a mobile phone (e.g., a smart phone, a radiotelephone, etc.), a laptop computer, a desktop computer, a tablet computer, a handheld computer, a wearable communication device (e.g., a smart wristwatch, a pair of smart eyeglasses, etc.), or a similar type of device. In some implementations, user device 205 may include one or more medical devices (e.g., sensors, monitors, etc.) via which data may be gathered.

Server device 210 includes one or more devices capable of receiving, collecting, obtaining, gathering, storing, processing, and/or providing information associated with a patient and/or a treatment associated with the patient. For example, server device 210 may include a server or a group of servers. In some implementations, server device 210 may include a device that stores or has access to patient information that is to be used by operations platform 215. In some implementations, server device 210 may be capable of providing information to operations platform 215.

Operations platform 215 includes one or more devices capable of receiving, determining, processing, storing, and/or providing information associated with one or more operations associated with a client and/or a workflow associated with the client. For example, operations platform 215 may include a server or a group of servers. In some implementations, operations platform 215 may host a suite of applications associated with the one or more operations. In some implementations, operations platform 215 may include a workflow orchestration component as described herein.

In some implementations, as shown, operations platform 215 may be hosted in cloud computing environment 220. Notably, while implementations described herein describe operations platform 215 as being hosted in cloud computing environment 220, in some implementations, operations platform 215 may not be cloud-based or may be partially cloud-based.

Cloud computing environment 220 includes an environment that hosts operations platform 215. Cloud computing environment 220 may provide computation, software, data access, storage, etc. services that do not require end-user (e.g., user device 205) knowledge of a physical location and configuration of system(s) and/or device(s) that hosts operations platform 215. As shown, cloud computing environment 220 may include a group of computing resources 222 (referred to collectively as “computing resources 222” and individually as “computing resource 222”).

Computing resource 222 includes one or more personal computers, workstation computers, server devices, or another type of computation and/or communication device. In some implementations, computing resource 222 may host operations platform 215. The cloud resources may include compute instances executing in computing resource 222, storage devices provided in computing resource 222, data transfer devices provided by computing resource 222, etc. In some implementations, computing resource 222 may communicate with other computing resources 222 via wired connections, wireless connections, or a combination of wired and wireless connections.

As further shown in FIG. 2, computing resource 222 includes a group of cloud resources, such as one or more applications (“APPs”) 222-1, one or more virtual machines (“VMs”) 222-2, virtualized storage (“VSs”) 222-3, one or more hypervisors (“HYPs”) 222-4, or the like.

Application 222-1 includes one or more software applications that may be provided to or accessed by user device 205. Application 222-1 may eliminate a need to install and execute the software applications on user device 205. For example, application 222-1 may include software associated with operations platform 215 and/or any other software capable of being provided via cloud computing environment 220. In some implementations, one application 222-1 may send/receive information to/from one or more other applications 222-1, via virtual machine 222-2.

Virtual machine 222-2 includes a software implementation of a machine (e.g., a computer) that executes programs like a physical machine. Virtual machine 222-2 may be either a system virtual machine or a process virtual machine, depending upon use and degree of correspondence to any real machine by virtual machine 222-2. A system virtual machine may provide a complete system platform that supports execution of a complete operating system (“OS”). A process virtual machine may execute a single program, and may support a single process. In some implementations, virtual machine 222-2 may execute on behalf of a user (e.g., user device 205), and may manage infrastructure of cloud computing environment 220, such as data management, synchronization, or long-duration data transfers.

Virtualized storage 222-3 includes one or more storage systems and/or one or more devices that use virtualization techniques within the storage systems or devices of computing resource 222. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 222-4 provides hardware virtualization techniques that allow multiple operating systems (e.g., “guest operating systems”) to execute concurrently on a host computer, such as computing resource 222. Hypervisor 222-4 may present a virtual operating platform to the guest operating systems, and may manage the execution of the guest operating systems. Multiple instances of a variety of operating systems may share virtualized hardware resources.

Network 225 includes one or more wired and/or wireless networks. For example, network 225 may include a cellular network (e.g., a long-term evolution (LTE) network, a 3G network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 2 are provided as an example. In practice, there may be additional devices, fewer devices, different devices, or differently arranged devices than those shown in FIG. 2. Furthermore, two or more devices shown in FIG. 2 may be implemented within a single device, or a single device shown in FIG. 2 may be implemented as multiple, distributed devices. Additionally, one or more of the devices of environment 200 may perform one or more functions described as being performed by another one or more devices of environment 200.

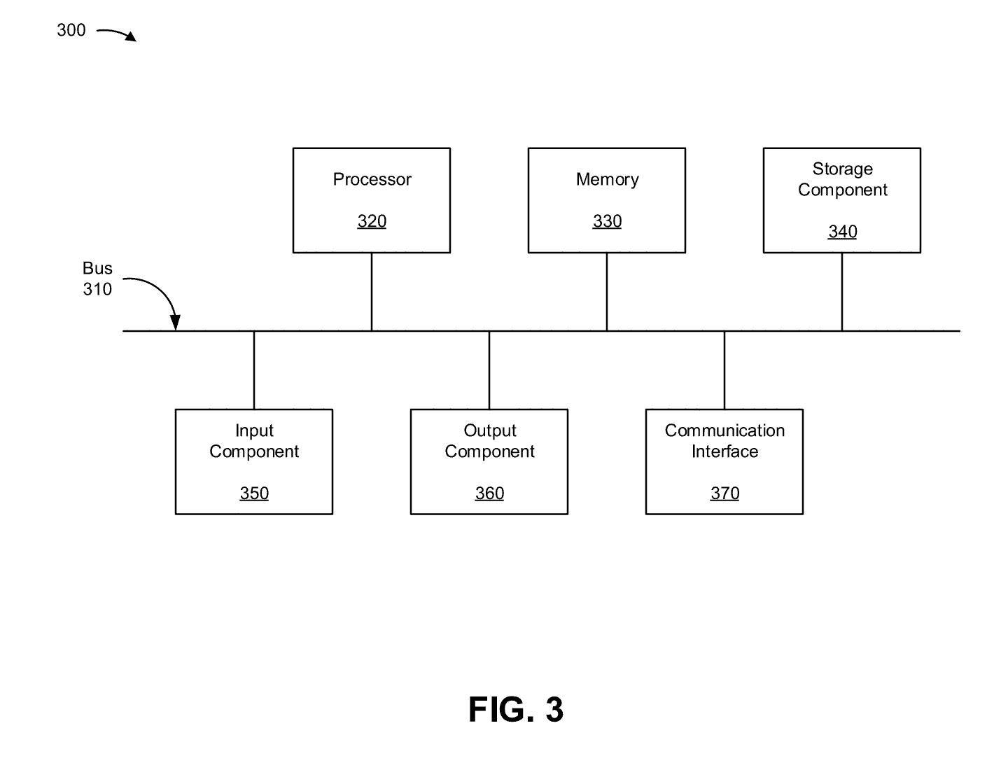

FIG. 3 is a diagram of example components of a device 300. Device 300 may correspond to user device 205, server device 210, and/or operations platform 215. In some implementations, user device 205, server device 210, and/or operations platform 215 may include one or more devices 300 and/or one or more components of device 300. As shown in FIG. 3, device 300 may include a bus 310, a processor 320, a memory 330, a storage component 340, an input component 350, an output component 360, and a communication interface 370.

Bus 310 includes a component that permits communication among the components of device 300. Processor 320 is implemented in hardware, firmware, or a combination of hardware and software. Processor 320 includes a processor (e.g., a central processing unit (CPU), a graphics processing unit (GPU), and/or an accelerated processing unit (APU)), a microprocessor, a microcontroller, and/or any processing component (e.g., a field-programmable gate array (FPGA) and/or an application-specific integrated circuit (ASIC)) that interprets and/or executes instructions. In some implementations, processor 320 includes one or more processors capable of being programmed to perform a function. Memory 330 includes a random access memory (RAM), a read only memory (ROM), and/or another type of dynamic or static storage device (e.g., a flash memory, a magnetic memory, and/or an optical memory) that stores information and/or instructions for use by processor 320.

Storage component 340 stores information and/or software related to the operation and use of device 300. For example, storage component 340 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 350 includes a component that permits device 300 to receive information, such as via user input (e.g., a touch screen display, a keyboard, a keypad, a mouse, a button, a switch, and/or a microphone). Additionally, or alternatively, input component 350 may include a sensor for sensing information (e.g., a global positioning system (GPS) component, an accelerometer, a gyroscope, and/or an actuator). Output component 360 includes a component that provides output information from device 300 (e.g., a display, a speaker, and/or one or more light-emitting diodes (LEDs)).

Communication interface 370 includes a transceiver-like component (e.g., a transceiver and/or a separate receiver and transmitter) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, or the like.

Device 300 may perform one or more processes described herein. Device 300 may perform these processes in response to processor 320 executing software instructions stored by a non-transitory computer-readable medium, such as memory 330 and/or storage component 340. A computer-readable medium is defined herein as a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 3 are provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

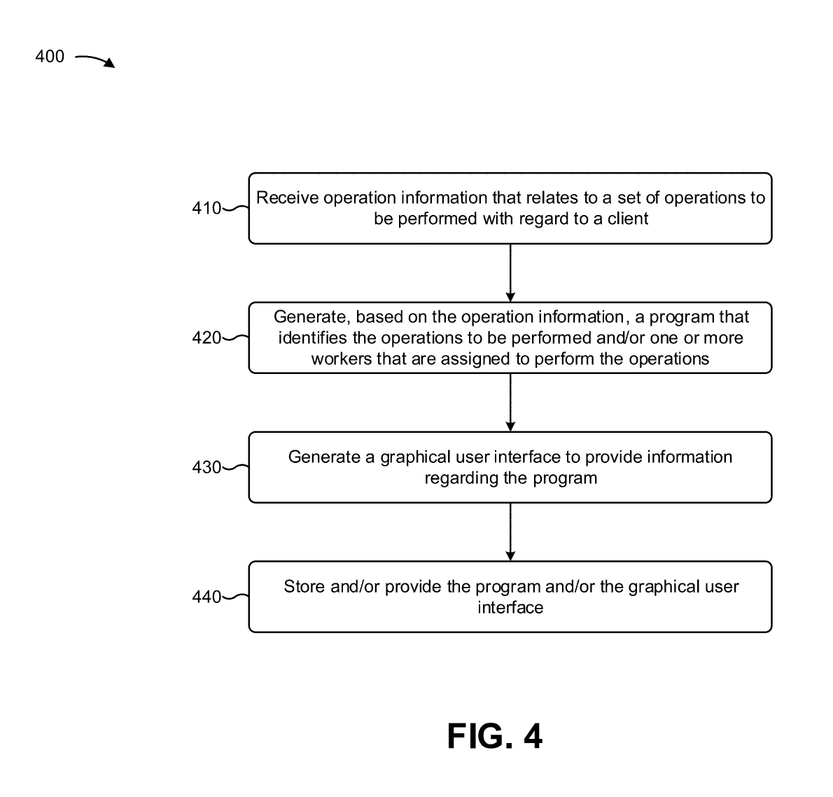

FIG. 4 is a flow chart of an example process 400 for generating a program based on operations to be performed with regard to a client. In some implementations, one or more process blocks of FIG. 4 may be performed by operations platform 215 (e.g., operations platform 215 of cloud computing environment 220). In some implementations, one or more process blocks of FIG. 4 may be performed by another device or a group of devices separate from or including operations platform 215, such as user device 205 and/or server device 210.

As shown in FIG. 4, process 400 may include receiving operation information that relates to a set of operations to be performed with regard to a client (block 410). For example, operations platform 215 may receive operation information from user device 205. In some implementations, the operation information may identify a set of operations to be performed with regard to a client (e.g., a patient, a customer, or any other recipient of services relating to the set of operations). As an example, the client may be a patient and the set of operations may relate to a treatment plan for the patient.

The set of operations may include, for example, enrolling a client in treatment, performing treatment, providing treatment instructions (e.g., treatment adherence instructions), assessing patient condition (e.g., response to treatment), or the like. For example, an operation may include obtaining sensor measurements (e.g., temperature, heart rate, or blood pressure), providing therapy (e.g., physical therapy, occupational therapy, or psychotherapy), administering medications (e.g., providing medications, or providing information associated with medications), extracting and/or maintaining material (e.g., blood, tissue, or excretions) for diagnostic testing or donation, administering a survey (e.g., with respect to symptoms or side effects), measuring responses to stimuli, or the like. Other examples are possible, and the operations to be performed are not limited to the above examples. Indeed, an operation may include any action to be performed with regard to a client, and need not be limited to the health care, life sciences, or related fields.

In some implementations, the operation information may identify criteria of the workers to be eligible to perform the operations (e.g., education criteria, qualification criteria, experience criteria, location criteria, or the like). For example, different operations, of the set of operations, may be associated with different criteria or requirements. The operation information pertaining to each operation, of the set of operations, may identify respective criteria associated with each operation. Operations platform 215 may assign operations to be performed by workers based on comparing the criteria or requirements to information associated with the workers.

In some implementations, the operation information may identify an order in which the operations are to be performed. For example, the operation information may identify a dependency of two or more operations (e.g., step A must be performed before step B, certain data must be obtained before performing a step, or the like) or logical relationships between steps (e.g., IF a particular condition is TRUE, perform step A; ELSE perform step B). As another example, the operation information may identify types of operations, based on which operations platform 215 may determine an order in which the operations are to be performed. As yet another example, the operation information may identify inputs and outputs of the operations, based on which operations platform 215 may determine the order.

In some cases, the operation information may be configured based on a template that corresponds to a particular type of service. For example, the operation information (e.g., the operations prescribed by the operation information, the formatting of the operation information, etc.) may be configured based on a diabetes treatment template, a 12 week rehabilitation plan template, or a similar template. In some implementations, operations platform 215 may provide an interface (e.g., a user interface) for inputting the operation information based on the template. For example, the user interface may include elements that permit a user to specify particular operations to be performed, an order in which operations are to be performed, or the like. In such a case, operations platform 215 may process the operation information based on the template, which may conserve computing resources that would otherwise be used to process, normalize, or identify operation information that is not associated with a template.

In some implementations, operations platform 215 may receive client information that relates to the client (e.g., client history, previous operations performed, or the like). For example, the client information may relate to attributes of a patient, such as medical history, health indicators, patient-provided information, pharmaceuticals, performance on tasks, lab results, insurance information, provider notes, patient preferences, or the like. Additionally, or alternatively, the client information may include geographical information (e.g., based on a previously entered address, Global Positioning System (GPS) coordinates of a device associated with the client, or the like). The client information may be received from the client (e.g., via user device 205), from an entity that provides the operation information, or the like.

In some implementations, operations platform 215 may receive or obtain the operation information automatically. For example, operations platform 215 may automatically generate the operation information according to a template and based on patient information associated with the patient (e.g., may generate an exercise program based on a height and weight of a patient). Additionally, or alternatively, operations platform 215 may generate or modify the operation information based on a result of performing one or more operations (e.g., based on performance information obtained based on performing the one or more operations). In some implementations, operations platform 215 may automatically receive the operation information periodically (e.g., for a weekly treatment to be administered to a patient, etc.). In some implementations, operations platform 215 may receive or obtain the operation information based on a user input. For example, a user may input the operation information to user device 205, and user device 205 may provide the operation information to operations platform 215.

In some implementations, operations platform 215 may determine the operation information based on a model. For example, the model may receive, as input, client information, and may output operation information regarding the patient. In some implementations, the model may be trained based on an artificial intelligence system, such as a machine learning algorithm. For example, the model may be trained based on client information regarding a set of clients and based on information that identifies successful operations, unsuccessful operations, cost-effective operations, or the like, for the set of clients. By training the model based on an artificial intelligence system, operations platform 215 may improve accuracy of operation information outputted by the model, may conserve organizational resources that would otherwise be used to manually determine operation information, and may permit determination of correlations, research, or the like based on the model.

As further shown in FIG. 4, process 400 may include generating, based on the operation information, a program that identifies the operations to be performed and/or one or more workers that are assigned to perform the operations (block 420). For example, operations platform 215 may generate the program based on the operation information. In some implementations, the program may identify the set of operations to be performed with regard to the client, and may identify the client information associated with the client.

The program may identify the set of operations to be performed with regard to the client. Additionally, or alternatively, the program may identify an order in which the set of operations are to be performed, and/or may identify logical relationships between the operations. In some implementations, operations platform 215 may determine the order in which the operations are to be performed based on the operation information associated with the operations. For example, the operation information may identify the order. As another example, operations platform 215 may determine the order based on inputs and/or outputs of operations (e.g., when a first operation is to obtain or determine information that is used as an input to a second operation).

In some implementations, operations platform 215 may determine the order of the operations based on one or more rules, based on business logic, or the like. For example, assume that a rule indicates that an operation of a first type (e.g., an operation to determine a body weight of a client) is to precede an operation of a second type (e.g., an operation to determine a dosage of medication for the client). In that case, when determining an order of operations that include an operation of the first type and an operation of the second type, operations platform 215 may determine that the operation of the first type is to be performed before the operation of the second type. As another example, operations platform 215 may determine that operations of a patient care type are to be performed before operations of a billing type. Thus, operations platform 215 automatically determines the order in which operations are to be performed, which conserves computing resources that would otherwise be used to determine the order manually, and which reduces variability of performance of the operations.

In some implementations, the program may identify client information associated with particular operations. For example, the program may identify a geographical location at which an operation is to be performed. As another example, if an attribute of a client is needed to perform an operation, the operation information may identify the attribute (e.g., a medical history, a body weight, medical allergies, etc.). As yet another example, if operations platform 215 stores or has access to information regarding previous operations performed for the client that are relevant to a particular operation of the program, the program may include the information regarding the previous operations.

In some implementations, the program may include or be associated with assignment information that identifies particular workers that are to perform one or more of the operations. In some implementations, each operation of the program may be assigned to the same worker. In some implementations, different operations of a program may be assigned to be performed by two or more different workers. For example, operations platform 215 may assign operations based on expertise levels of workers (e.g., when a worker meets a requirement associated with an operation), an availability of the workers, a random selection, a skill required to perform the particular operations, a level of experience of the one or more workers, geographic proximity of the one or more workers to the location associated with the client, one or more past operations performed by the one or more workers with regard to the client, or any other criterion. Additionally, or alternatively, operations may be assigned based on worker selections. For example, a worker may select which operations to perform via the user interface generated by operations platform 215.

In some implementations, operations platform 215 may determine assignment information based on a model that is trained, for example, based on a machine learning algorithm, or the like. For example, operations platform 215 may assign workers to perform operations, and may receive performance information that indicates whether the workers successfully performed the operations. Based on the performance information, and based on attributes of the workers (e.g., expertise, experience, location, etc.), operations platform 215 may train a model for assigning the operations. The model may receive input information that identifies a set of workers and a set of operations. Based on the input information, the model may output assignment information that identifies assignments of the set of operations to be performed by the set of workers. Thus, operations platform 215 improves efficiency of assigning the operations and conserves computing resources that would otherwise be used to manually assign the operations or manually define rules for assigning operations.

Operations platform 215 may update the model based on results of performing the set of operations. For example, based on a machine learning algorithm, operations platform 215 may use performance information corresponding to the set of operations to update the model. By iteratively updating the model based on performance information for a set of workers, operations platform 215 improves performance of the model and, thus, improves efficiency of the set of workers and of performance of the set of operations.

In some implementations, operations platform 215 may encrypt the program, which may increase security of the program. Additionally, or alternatively, operations platform 215 may require one or more credentials to access information regarding the program. For example, different workers may be associated with different credentials, and operations platform 215 may control access to information associated with the program based on receiving and authenticating the credentials. In this case, operations platform 215 may provide access to different levels of detail, different sets of information, information relating to particular operations, or the like, based on levels of authorization associated with the one or more credentials. Thus, security of the program is improved.

As further shown in FIG. 4, process 400 may include generating a graphical user interface to provide information regarding the program (block 430). For example, operations platform 215 may generate a graphical user interface to provide information regarding the program. In some implementations, the graphical user interface may provide information regarding the entire program (e.g., to an administrator of the program, etc.). In some implementations, the graphical user interface may provide information regarding a portion of the program. For example, when presenting information relating to particular operations to be performed by a worker, the graphical user interface may provide information relating to the particular operations to be performed by the worker. As another example, when providing information to an entity associated with an insurance company, the graphical user interface may provide information helpful to the entity associated with the insurance company (e.g., based on a request for the information, based on a template, based on a configuration of the graphical user interface, or the like).

The graphical user interface may provide information relevant to performing the one or more operations. For example, when an operation relates to obtaining a particular measurement, the graphical user interface may provide instructions for obtaining the particular measurement, a field in which to show or receive a value of the particular measurement, a field in which to show or receive notes regarding the operation, or the like. Additionally, or alternatively, the graphical user interface may provide client information relating to a client for which the one or more operations are to be performed. For example, when the client is a patient, the graphical user interface may provide medical information for the patient, a treatment history of the patient, recent comments by the patient, or the like. By providing information relevant to performing assigned operations, operations platform 215 facilitates efficient performance of the assigned operations and conserves computational resources that would otherwise be used to search for and find the relevant information.

In some implementations, the graphical user interface may permit a user to input information regarding an operation and/or a client. For example, the user may input performance information to specify that an operation has been completed, or that an operation cannot be completed. Additionally, or alternatively, a worker may input information collected in the course of performing the operation, such as observations regarding an operation, statements made by the client, or the like. This information may be provided to operations platform 215, which may use the information to improve provision of operations and/or to update operations (e.g., based on a model, based on observations regarding effectiveness of a particular operation, etc.). Thus, efficiency of performance of operations with regard to a client is improved.

In some implementations, operations platform 215 may generate the graphical user interface, and may provide the graphical user interface to a user device 205 associated with a worker, as described in more detail below. In some implementations, a device other than operations platform 215 may generate the graphical user interface. For example, operations platform 215 may provide the program to another device (e.g., user device 205 or server device 210) and the other device may generate the graphical user interface based on the program.

As further shown in FIG. 4, process 400 may include storing and/or providing the program and/or the graphical user interface (block 440). For example, operations platform 215 may store and/or provide the program and/or the graphical user interface. In some implementations, operations platform 215 may provide at least a portion of the program and/or the graphical user interface to user devices 205 associated with one or more workers who are to perform the set of operations. The workers may perform the operations based on the graphical user interface, and may input performance information to user device 205 via the graphical user interface, to be provided to operations platform 215.

In some implementations, operations platform 215 may provide the program and/or the graphical user interface to user device 205 for later use. For example, operations platform 215 may provide the program and/or the graphical user interface when operations platform 215 is connected with user device 205 (e.g., via the Internet, a WiFi connection, a cellular network connection, etc.), and user device 205 may store the program and/or the graphical user interface for later use (e.g., when user device 205 is not connected with operations platform 215). In this way, operations platform 215 enables user device 205 to support performance of operations when user device 205 is not connected to operations platform 215 (e.g., when user device 205 is isolated from connecting to operations platform 215).

In some implementations, operations platform 215 may store the program and/or the graphical user interface locally, and may provide access to the program and/or the graphical user interface. For example, user device 205 may establish a secure session with operations platform 215, and operations platform 215 may provide access to the graphical user interface via the secure session. In this way, operations platform 215 improves security of the graphical user interface and conserves resources of user device 205 that would otherwise be used by user device 205 to locally store and provide the graphical user interface.

In some implementations, operations platform 215 may securely store and/or provide the program (e.g., based on encrypting the program). Additionally, or alternatively, operations platform 215 may require a credential, such as a password, a key, or the like, to access the program. In some implementations, different entities may be associated with different credentials, and the different credentials may provide access to respective portions of the program. For example, a worker may be associated with a first type of credential, and an administrator may be associated with a second type of credential. Operations platform 215 may provide access to the program and/or the graphical user interface based on a type of credential associated with a device that accesses the program and/or graphical user interface. Thus, operations platform 215 improves security of the program.

In some implementations, operations platform 215 may provide different portions of the program to different workers. For example, the different workers may be assigned operations corresponding to the different portions, and operations platform 215 may provide each portion to the worker that has been assigned the corresponding operations. In some implementations, operations platform 215 may select a portion of the program to provide to a particular entity based on a type of the entity. For example, operations platform 215 may provide a first portion of the program to a field nurse, may provide a second portion of the program to a billing specialist, may provide a third portion of the program to an administrator, and so on.

In some implementations, operations platform 215 may provide part of, or all of, a program to user device 205 based on a location of user device 205. For example, assume that a program identifies operations to be performed at a location by a worker. In such a case, operations platform 215 may provide the program to user device 205 when user device 205 is located near the location. This may improve security of the program by reducing a likelihood that a malicious party can obtain the program at an unauthorized location. As another example, a particular location may be identified as a secure location (e.g., a home office associated with operations platform 215, a hospital, a medical office, etc.), and operations platform 215 may provide information to user device 205 only when user device 205 is located at the secure location. Thus, security of the information is further improved.

In this way, operations platform 215 automatically generates a program based on determining an order in which operations are to be performed and based on client information that is relevant to performing the operations, which improves efficiency of performing the operations and conserves computing resources that would otherwise be used to manually specify the order or generate and administer the program. Furthermore, operations platform 215 generates graphical user interfaces based on the program, which may provide information relevant to operations to be performed by a worker, information relevant to administration of the program, information useful to an insurance, health care, or life sciences entity, or the like. Thus, computing resources are conserved that would otherwise be used to manually obtain or compile this information.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

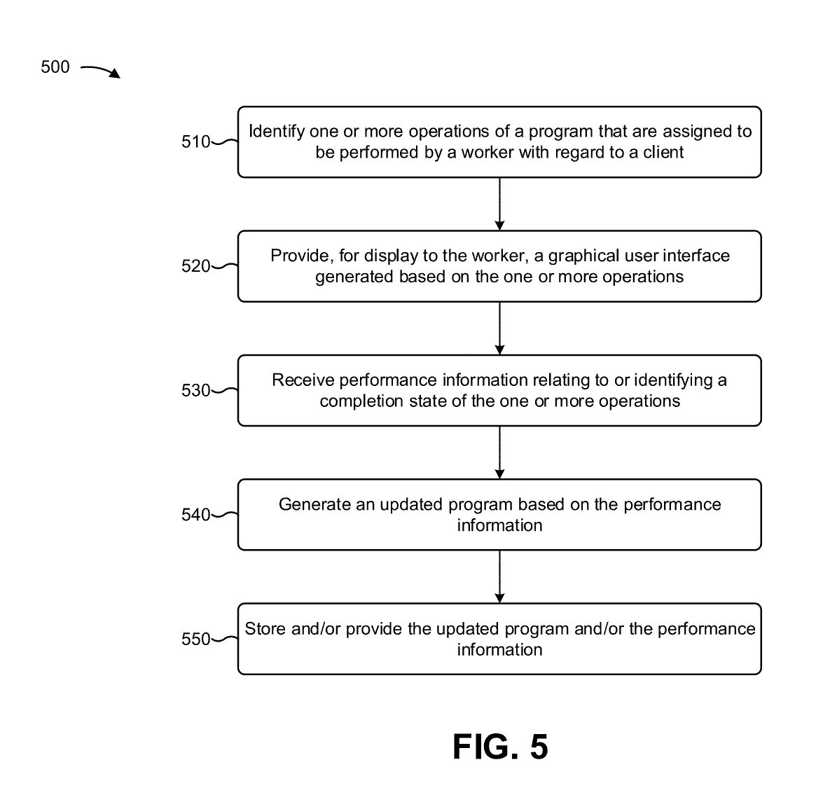

FIG. 5 is a flow chart of an example process 500 for providing an updated program based on completion of operations to be performed with regard to a client. In some implementations, one or more process blocks of FIG. 5 may be performed by operations platform 215. In some implementations, one or more process blocks of FIG. 5 may be performed by another device or a group of devices separate from or including operations platform 215, such as user device 205 and/or server device 210.

As shown in FIG. 5, process 500 may include identifying one or more operations of a program that are assigned to be performed by a worker with regard to a client (block 510). For example, operations platform 215 may identify one or more operations of a program that are assigned to be performed by a worker. In some implementations, operations platform 215 may identify the one or more operations that are assigned to the worker based on assignment information indicating that the one or more operations are assigned to the worker. For example, the assignment information may be included in the program, and/or may be determined when the program is generated. Additionally, or alternatively, operations platform 215 may receive an instruction to cause the one or more operations to be performed, and may assign the one or more operations to be performed based on the instruction.

As further shown in FIG. 5, process 500 may include providing, for display to the worker, a graphical user interface generated based on the one or more operations (block 520). For example, operations platform 215 may generate the graphical user interface, and may provide the graphical user interface to user device 205 for display to the worker, as described in more detail above. Additionally, or alternatively, operations platform 215 may provide information associated with the operations (e.g., operation information, client information, information identifying the program, etc.), and user device 205 may generate the graphical user interface based on the information in a manner similar to what is described in connection with FIG. 4, above. Based on information displayed to the worker via the graphical user interface, the worker may perform the one or more operations with regard to the client. Thus, operations platform 215 facilitates performance of operations of a workflow by providing a graphical user interface that identifies information useful for performing the one or more operations.

As further shown in FIG. 5, process 500 may include receiving performance information relating to or identifying a completion state of the one or more operations (block 530). For example, operations platform 215 may receive performance information from user device 205. In some implementations, the performance information may identify a completion state of the one or more operations. For example, the performance information may indicate whether each operation, of the one or more operations, has been performed. Additionally, or alternatively, the performance information may include information relating to performance of the one or more operations. For example, the performance information may include measurements obtained by user device 205 during performance of the one or more operations, observations inputted by a worker associated with user device 205, or the like.

In some implementations, operations platform 215 may receive the performance information based on a user inputting the performance information to user device 205. For example, a worker associated with user device 205 may interact with the graphical user interface to mark operations as completed, or to provide relevant information as the worker performs the operations.

In some implementations, user device 205 may determine the performance information automatically. For example, user device 205 may automatically collect information (e.g., based on a sensor associated with user device 205) and may provide the collected information as performance information. As another example, assume that user device 205 is to display a training video for a particular operation. In this case, user device 205 may determine that the particular operation has been completed when user device 205 displays the training video. By automatically determining performance information, user device 205 reduces reliance on manual input of performance information, thus improving accuracy of the performance information and reducing computing resource usage based on manual input of the performance information.

In some implementations, operations platform 215 may receive performance information for each operation assigned to a worker. For example, user device 205 may provide the performance information when all operations associated with the worker have been performed, which may conserve processor and/or other computational resources and network resources that would be used to transmit multiple batches of performance information. In some implementations, operations platform 215 may receive performance information for a particular operation. For example, user device 205 may provide performance information for a set of operations as each operation, of the set of operations, is completed, which may conserve resources of user device 205 that would otherwise be used to locally store a batch of performance information before the batch of performance information is provided.

In some implementations, operations platform 215 may automatically process performance information. For example, when operations platform 215 receives notes or comments regarding an operation, operations platform 215 may use natural language processing to identify content of the notes or comments in order to generate an updated program based on the notes or comments. By using natural language processing, operations platform 215 permits determination of content of notes or comments when the notes or comments do not follow a predetermined format, which improves versatility of operations platform 215, reduces reliance on manual interpretation of operation information, and increases usability of manually-inputted operation information.

As further shown in FIG. 5, process 500 may include generating an updated program based on the performance information (block 540). For example, operations platform 215 may generate an updated program based on the performance information. The updated program may identify one or more operations that have been performed, one or more operations that remain to be performed, information that has been received based on performing operations, or the like. Thus, when an entity accesses the updated program, the entity can see a comprehensive view of performance of the operations with regard to the client. In this way, visibility of performance of services is improved, processor and storage resources are conserved that would otherwise be used to store such information on user device 205, and/or information security of the performance information and/or client information is improved.

In some implementations, the updated program may include one or more different operations than the original program. For example, based on particular performance information, operations platform 215 may determine that a particular operation is to be performed with regard to a client (e.g., updating a medication based on a body temperature of a client, changing a treatment policy based on an observed reaction to a treatment, or the like). In such a case, operations platform 215 may generate an updated program that identifies the particular operation and/or that assigns the particular operation to be performed by a worker. Operations platform 215 may identify the operation to be added based on a workflow corresponding to the program. For example, the workflow may identify the operation to be added and may include information (e.g., a logical relationship, an order of operations, etc.) that indicates when the operation is to be added. Operations platform 215 may determine that the operation is to be added based on the information included in the workflow. Thus, operations platform 215 enables modification of a program based on a workflow, which improves versatility of workflows that can be administered by operations platform 215.

In some implementations, operations platform 215 may modify one or more operations based on the performance information. For example, assume that a worker provides performance information that identifies a particular dose of medication to be administered and a predicted level of activity associated with a client. In such a case, operations platform 215 may modify a later dose of the medication based on the predicted level of activity and the particular dose. Thus, operations platform 215 permits enhancement to delivered care based on real-time or near real-time (e.g., real time or substantially real-time) data flow.

In some implementations, operations platform 215 may modify an operation based on a model. The model may receive, as input, a program, client information, operation information, and/or performance information regarding operations to be performed for the client. The model may output a modification to the program and/or the operations to be performed. In such a case, the model may be trained and/or updated based on a machine learning algorithm or another form of artificial intelligence. For example, the model may be trained and/or updated based on a training set that includes programs, client information, operation information, performance information, or the like. By training and/or updating the model, operations platform 215 improves administration of delivered care and reduces reliance on manually defined rules.

In some implementations, operations platform 215 may generate an updated graphical user interface based on the updated program. The updated graphical user interface may identify performed operations, may identify client information associated with performed operations, may identify client information associated with operations yet to be performed, or the like. For example, the updated graphical user interface may provide information that identifies a completion state of operations of the program that provides client information relating to the updated program, or the like.

As further shown in FIG. 5, process 500 may include storing and/or providing the updated program and/or the performance information (block 550). For example, operations platform 215 may store and/or provide the updated program and/or the performance information. In some implementations, operations platform 215 may provide (e.g., synchronize) the updated program and/or performance information to one or more devices. For example, when multiple workers are to perform respective operations for a client, operations platform 215 may synchronize user devices 205, associated with the multiple workers, based on the updated program, thereby reducing redundant performance of operations. In such a case, user device 205 may update a graphical user interface, generated by user device 205, based on the updated program and/or performance information.

In some implementations, operations platform 215 may provide the updated program and/or performance information when a connection with user device 205 is established. This permits operations platform 215 to synchronize programs and/or client information with user devices 205 as user devices 205 establish connections with operations platform 215, thereby permitting user devices 205 to perform operations or provide information relating to performing operations when isolated from operations platform 215. In some implementations, operations platform 215 may provide the updated program and/or performance information via a secure connection. For example, operations platform 215 may establish an encrypted session, a session associated with a particular location, or the like. By providing the updated program and/or the performance information via the secure session, operations platform 215 improves security of the updated program and/or the performance information.

In some implementations, operations platform 215 may provide information indicating that operations platform 215 has generated the updated program. For example, operations platform 215 may provide a message (e.g., a text message, an email message, a phone call, etc.) to user device 205 associated with one or more workers. In such a case, the message may cause user device 205 to connect with operations platform 215 to obtain the updated program. Additionally, or alternatively, the message may instruct a worker associated with user device 205 to move to a secure location to obtain the update.

In some implementations, operations platform 215 may provide an updated graphical user interface based on the updated program. For example, operations platform 215 may provide the updated graphical user interface to a device that accesses the updated program and/or performance information. As another example, operations platform 215 may generate an updated graphical user interface, and may provide the updated graphical user interface to one or more user devices 205 associated with the set of operations (e.g., to facilitate performance of remaining operations of the set of operations).

The updated graphical user interface may provide information regarding the updated program (e.g., one or more modified operations, one or more newly assigned operations to perform, completion states of completed operations and/or incomplete operations, client information associated with the updated program, etc.). Based on the updated graphical user interface, workers may perform modified operations, newly assigned operations, or the like. Thus, operations platform 215 facilitates modification of client services in real-time or near real-time (e.g., real time or substantially real-time), which improves provision of client services.

In this way, operations platform 215 enables administration and modification of a set of operations in real-time or near real-time (e.g., real-time or substantially real-time) based on performance information relating to performance of the set of operations. Furthermore, operations platform 215 synchronizes a program and/or an updated program to user devices 205 associated with workers that are to perform the operations, thus improving efficiency of performing the set of operations. Still further, operations platform 215 improves security of data associated with performance of the operations.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

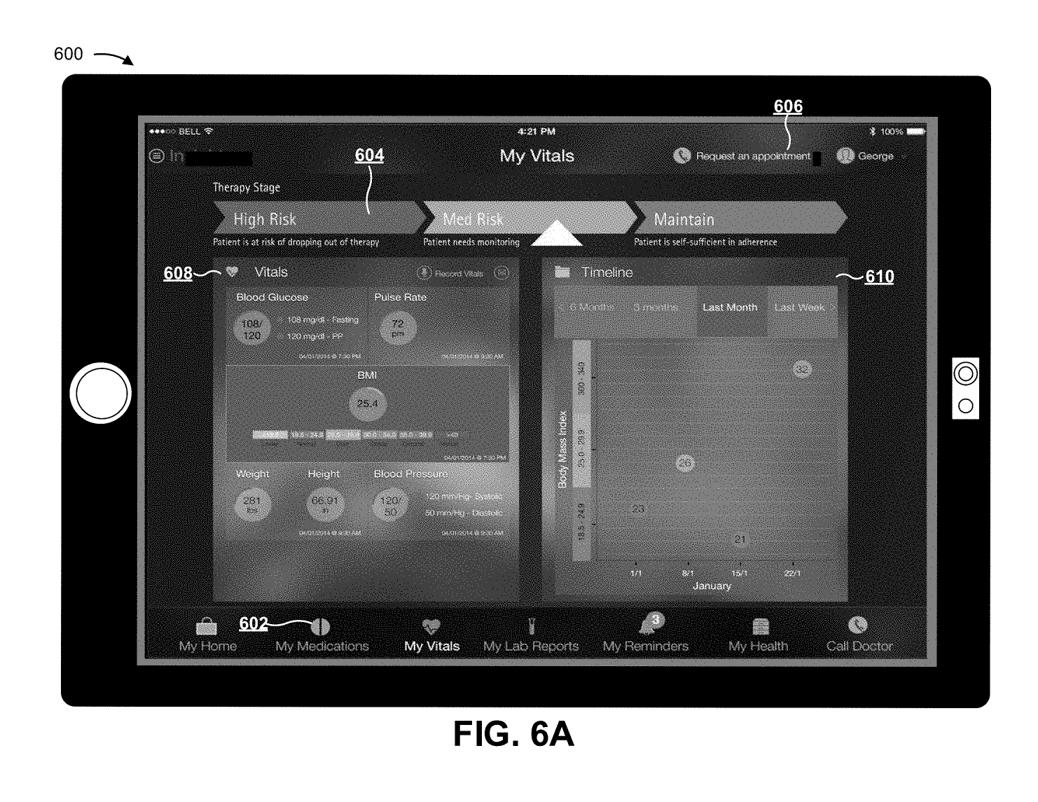

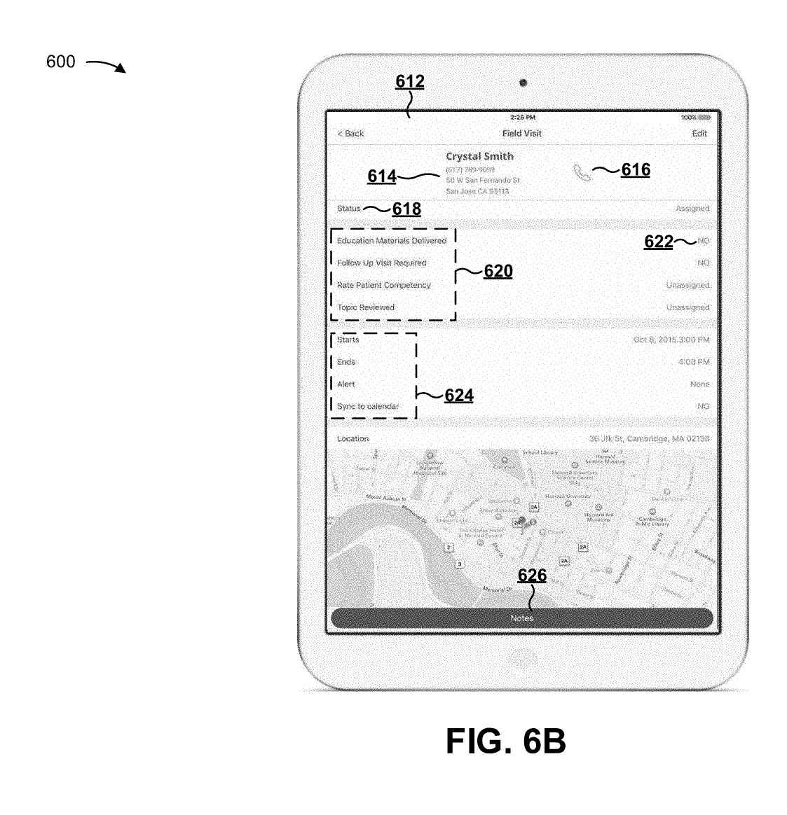

FIGS. 6A and 6B are diagrams of example graphical user interfaces 600 that may be generated based on example processes 400 and 500, shown in FIGS. 4 and 5.

FIG. 6A shows an example of a client interface portion of graphical user interface 600 that may be provided to a client (e.g., a patient) by which the client can access client information. As shown in FIG. 6A, the client interface includes a client menu of selectable menu items, such as a “My Medications” icon (shown by reference number 602) which the client may select to view medications prescribed for the client (e.g., displayed on a medications screen). In this case, as a “My Vitals” icon has been most recently selected from the client menu, a vitals screen is currently displayed, as shown.

As further shown in FIG. 6A, the client interface includes a risk indicator (shown by reference number 604) indicating a risk level (e.g., of a risk to the patient with respect to progress in therapy). As further shown in FIG. 6A, the client interface includes a call button (shown by reference number 606) which the client may select to cause user device 205 to call a healthcare professional in order to request an appointment. As further shown in FIG. 6A, the client interface includes a vitals section (shown by reference number 608) by which the client can view vital statistics (e.g., blood glucose, pulse rate, body mass index (BMI), weight, height, blood pressure, or the like). As further shown in FIG. 6A, the client interface includes a timeline section (shown by reference number 610) by which the client can monitor a condition (e.g., BMI) over time.

As shown in FIG. 6B, user device 205 may display user interface 600 in a Field Visit view (shown by reference number 612) for a selected client based on receiving a user selection of the selected client, as described above. In the Field Visit view, user interface 600 may include a contact field (shown by reference number 614) that provides a name, address, phone number, or the like, of the client. The worker may use this information to contact or travel to the client. User interface 600 may further include a call button (shown by reference number 616), which may cause user device 205 to call the client at the phone number. In some cases, the call button may cause user device 205 to cause an emergency line, a health care practitioner associated with the client, or the like.

As further shown, user interface 600 may include a status field (shown by reference number 618) which indicates a status of the visit (e.g., Assigned, Completed, or the like). An assigned visit may be associated with an operation that has yet to be performed. A completed visit may be associated with an operation that has already been performed.

User interface 600 may further include a services section (shown by reference number 620) which lists operations to be performed, and which shows a status of each service (shown by reference number 622). Here, the operations include delivering educational materials (associated with an uncompleted status of NO), performing a follow-up visit (associated with an uncompleted status of NO), providing a rating of client competency (associated with an unassigned status, indicating that the operation has not been assigned to a worker), and reviewing a topic (associated with an unassigned status, indicating that the operation has not been assigned to a worker). In some implementations, the worker may change the status of an operation by selecting an operation field or the associated status field, which may cause user device 205 to prompt the worker to enter updated information.

User interface 600 may further include a scheduling section (shown by reference number 624) which shows a start and end time for the visit (e.g., a scheduled start time and end time, an actual start time and end time, an adjusted start time and end time based on extenuating circumstances, etc.), an indication of whether an alert has been set (e.g., a pop-up alert to remind a worker of the visit, an alert to be transmitted to the patient when the visit is about to occur, etc.), and an indication of whether the visit has been synchronized to a calendar (e.g., a calendar stored by user device 205, a calendar associated with the worker, a calendar associated with the patient, etc.). In some implementations, user device 205 may change the start time or end time, or may set an alert, or may enable a synchronization to a calendar, based on receiving an interaction with the corresponding field or status, which may cause user device 205 to prompt the worker to enter updated information. As shown by reference number 626, user interface 600 further includes a Notes button, which the worker may select to enter or view notes associated with the visit (e.g., notes that do not relate to an operation, notes in response to a prompt provided by user device 205, etc.).

FIGS. 6A and 6B are provided merely as an example. Other examples are possible and may differ from what was described in connection with FIGS. 6A and 6B.

By automatically tracking and administering performance of operations, the operations platform improves efficiency of performance of the operations and enables reconfiguration of the operations in real-time or near real-time (e.g., real-time or substantially real-time). Furthermore, by providing information regarding an updated program to one or more user devices, the operations platform may synchronize the user devices of multiple workers, clients, and/or administrators with regard to the status of the operations. In this way, uniformity of performance of operations is improved. Further, the operations platform may enable analysis of performance information relating to performance of operations, which improves provision of health related services.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, and/or a combination of hardware and software.

Some implementations are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

Certain user interfaces have been described herein and/or shown in the figures. A user interface may include a graphical user interface, a non-graphical user interface, a text-based user interface, etc. A user interface may provide information for display. In some implementations, a user may interact with the information, such as by providing input via an input component of a device that provides the user interface for display. In some implementations, a user interface may be configurable by a device and/or a user (e.g., a user may change the size of the user interface, information provided via the user interface, a position of information provided via the user interface, etc.). Additionally, or alternatively, a user interface may be pre-configured to a standard configuration, a specific configuration based on a type of device on which the user interface is displayed, and/or a set of configurations based on capabilities and/or specifications associated with a device on which the user interface is displayed.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A device, comprising:
one or more processors to:
receive operation information that identifies a plurality of operations to be performed with regard to a client by a plurality of workers;
generate, based on the operation information, a program that identifies the plurality of operations and an order in which the plurality of operations are to be performed,
the program including assignment information that identifies one or more workers, of the plurality of workers, that have been assigned to perform respective operations of the plurality of operations, and
the order being based on logical relationships between the plurality of operations;
provide, to one or more user devices associated with the one or more workers, respective portions of the program associated with the respective operations that are assigned to the one or more workers;
receive, from the one or more user devices, performance information that identifies completion states of the respective operations;
automatically generate an updated program based on the performance information,
the updated program including one or more modified operations that are determined based on one or more of the plurality of operations and the performance information; and
store and/or provide the updated program.

2. The device of claim 1, where the one or more processors are to:
provide a graphical user interface to the one or more user devices,
the graphical user interface to provide, to the one or more workers, information regarding the respective operations and/or the program.

3. The device of claim 2, where the one or more processors, when providing the updated program, are further to:
modify the graphical user interface, based on the performance information, to generate an updated graphical user interface; and
provide the updated program via the updated graphical user interface.

4. The device of claim 2, where the one or more processors, when receiving the performance information, are to:
receive the performance information from the one or more user devices,
the performance information being received by the one or more user devices via the graphical user interface.

5. The device of claim 1, where the one or more processors are further to:
provide client information relating to the client,
the client information that is provided with the respective portions relating to performing the operations associated with the respective portions.

6. The device of claim 1, where the one or more processors are to:
assign the one or more modified operations to be performed by at least one of the plurality of workers.

7. The device of claim 1, where the one or more processors, when providing the updated program, are to:
determine that the one or more user devices are located at a particular location; and
provide the updated program to the one or more user devices based on the one or more user devices being located at the particular location.

8. The device of claim 1, where the one or more processors, when receiving the performance information, are to:
receive the performance information based on one or more of:
information input to the one or more user devices by a worker of the one or more workers, or
information automatically obtained by the one or more user devices.

9. A method, comprising:
receiving, by a device, operation information that identifies a plurality of operations to be performed with regard to a client by one or more workers;
generating, by the device and based on the operation information, a program that identifies the plurality of operations and an order in which the plurality of operations are to be performed,
the program including assignment information that identifies particular operations, of the plurality of operations, that have been assigned to be performed by the one or more workers, and
the order being based on logical relationships between the plurality of operations;
providing, by the device and to one or more user devices associated with the one or more workers, a graphical user interface,
the graphical user interface being generated based on the program, and
the graphical user interface providing information relevant to performing the operations that have been assigned to the one or more workers;
receiving, by the device, performance information that identifies a completion state of the plurality of operations;
generating, by the device, an updated program based on the performance information,
the updated program identifying one or more incomplete operations of the plurality of operations and one or more completed operations of the plurality of operations; and
storing and/or providing, by the device, the updated program.

10. The method of claim 9, further comprising:
determining, based on the operation information, the order in which the plurality of operations are to be performed,
the order being based on one or more of:
a dependency of a first operation, of the plurality of operations, on a second operation of the plurality of operations, or
a conditional relationship between a first operation, of the plurality of operations, and a second operation of the plurality of operations.

11. The method of claim 9, where generating the updated program comprises:
identifying, based on the performance information, a modification to the order in which the plurality of operations are to be performed; and
assigning the one or more incomplete operations to be performed based on the modification to the order.

12. The method of claim 9, where the graphical user interface is a first graphical user interface; and
where the method further comprises:
providing a second graphical user interface that identifies each operation of the plurality of operations.

13. The method of claim 9, further comprising:
assigning the particular operations to be performed by the one or more workers based on client information associated with the client,
the client information including one or more of medical information associated with the client or location information that identifies a location associated with the client.

14. The method of claim 13, where assigning the particular operations comprises:
assigning the particular operations based on one or more of:
a skill required to perform the particular operations,
a level of experience of the one or more workers,
geographic proximity of the one or more workers to the location associated with the client, or
one or more operations previously performed by the one or more workers with regard to the client.

15. The method of claim 13, where assigning the particular operations comprises:
assigning the particular operations based on a model,
the model receiving, as input, the operation information and information identifying the one or more workers, and
the model outputting the assignment information.

16. The method of claim 15, where the model is trained based on a machine learning algorithm,
the model being trained based on past performance information that identifies past performance of a plurality of workers with regard to operations assigned to the plurality of workers.

17. A non-transitory computer-readable medium storing instructions, the instructions comprising:
one or more instructions that, when executed by one or more processors, cause the one or more processors to:
receive operation information that identifies a plurality of operations to be performed with regard to a client by a plurality of workers;
generate, based on the operation information, a program that identifies the plurality of operations and an order in which the plurality of operations are to be performed,
the program including assignment information that identifies one or more workers, of the plurality of workers, that have been assigned to perform respective operations of the plurality of operations;
provide, to one or more user devices associated with the one or more workers, respective portions of the program associated with the respective operations that are assigned to the one or more workers;
receive, from the one or more user devices, performance information that identifies completion states of the respective operations;
automatically generate an updated program based on the performance information,
the updated program identifying one or more incomplete operations, of the plurality of operations, and one or more completed operations of the plurality of operations; and
store and/or provide the updated program.

18. The non-transitory computer-readable medium of claim 17, where the one or more instructions, that cause the one or more processors to provide the respective portions of the program, further cause the one or more processors to:
provide the respective portions via a graphical user interface,
the graphical user interface providing information, relating to the client, that is needed to perform the respective operations.

19. The non-transitory computer-readable medium of claim 18, where the one or more instructions, that cause the one or more processors to receive the performance information, further cause the one or more processors to:
receive the performance information based on the performance information being inputted to the graphical user interface.

20. The non-transitory computer-readable medium of claim 17, where the one or more instructions, that cause the one or more processors to generate the updated program, cause the one or more processors to:
modify a particular operation of the one or more incomplete operations based on a value included in the performance information; and
assign the particular operation to be performed by one of the plurality of workers.
